(19) United States
(12) Patent Application Publication
(10) Pub. No.: US 2011/0218937 A1
(43) Pub. Date: Sep. 8, 2011

(54) System and Methods for Management of Real Property

(76) Inventor: Jeremy Elser, Philadelphia, PA (US)

(21) Appl. No.: 12/716,750

(22) Filed: Mar. 3, 2010

(51) Int. Cl. G06Q 40/00; G06Q 50/00; G06Q 90/00

(52) U.S. Cl. 705/36 T; 705/36 R; 705/500

(57) ABSTRACT

Computer systems and methods enable an individual to simulate real estate/financial transactions over time, provide accounting and cash flow management for management of real estate investments, and track property values for rental properties taking into account tenant creditworthiness (tenant credit score) and the like. The computer system calculates a tenant reliability score (TRS) that can be used when an individual real estate investor is contemplating whether to enter into a lease with a tenant. A lower TRS would alert the landlord that the tenant may not be a good risk which would decrease the expected future value of rental property. A simulator preferably incorporates the TRS into cash flow projections such that the investor could compare different potential tenants and. Financial tracking modules enable the real estate investor to track the equity value of his or her real estate investments, cash flow, and to provide data useful for buy/sell decisions.

### TECHNICAL FIELD

The present invention relates to computer systems and methods for management of real property. In particular, the present invention relates to computer systems and methods by which an individual may simulate real estate/financial transactions over time, provide accounting and cash flow management for management of real estate investments, and track property values for rental properties taking into account tenant creditworthiness (tenant credit score) and the like.

### BACKGROUND

Many individuals, who are not real estate or accounting professionals, manage their own real estate investments. Successful management of real estate investments requires calculations based not only on known expenses and income, such as mortgage payments, rental income, and property taxes, but also on more subtle factors, such as the effect of national, regional, and local statistics and a tenant's past payment history on the particular property on the probability of rent collection for rental properties. Software is available that enables individuals to track real estate investments; however, conventional real estate management software is inflexible in that it generally cannot handle the myriad of available financing options and cannot adapt to account for the various types of expenses associated with real property that may occur at irregular intervals or at unexpected times. Moreover, conventional real estate management software is generally limited to the accounting and taxes aspect of running a real estate business and does not generally permit the property owner to manage the property and to evaluate tenants of the property. Moreover, conventional real estate management software does not permit the property owner to simulate changes to his or her finances in the event of changes such as a change in interest rate, a change in rent, a change in rental status, and the like.

An example of a conventional cash management system that may be used to manage real estate investments is described, for example, in U.S. Pat. No. 7,050,997 to Wood (the “Wood” patent). The Wood patent describes a method for analyzing cash flow finances provided all assets and liabilities are merely cash objects. However, both business and personal finances require accounting methods that incorporate all forms of assets and liabilities; simple cash flow actually yields a deceptive analysis of a person's or business's financial status. An accounting system more appropriate for real estate investment and that takes into consideration general accounting principles instead of a mere cash flow analysis is desired.

As many real estate investments include rental properties, it is also desirable to provide the property owner with tools for managing the property and the tenants. In addition, techniques are desired for permitting the property owners to better evaluate the merit of prospective tenants. Traditional credit scores consider a tenant's revenues and liabilities, as well as a tenant's generic past payment history to creditors, but do not incorporate the reliability of the tenant. It is desirable that more comprehensive tenant information be made available to the property owner so that the property owner may better evaluate the merit of one prospective tenant over another, or at least permit the property owner to evaluate his or her risk in renting to a particular tenant. For example, it is desired that the property owner be able to assess the reliability of a prospective tenant by taking into account the tenant's financial resources, liabilities, and past payment history along with national, regional, and/or local statistics. Payment history could be information on on-time lease payments, number of payments, days late per payment, and number of days and amount that a tenant is in arrears. It is further desired that payment history from past rentals be included, if that data is available.

In addition, individual real estate investors, to be successful, must have a method of determining a true net worth of their real estate investments, which comprises actual outflow (expenses such as mortgage interest and taxes), but also must take into account that mortgage principal payments do not detract from net worth, and that the depreciation may reduce current taxes due. An automated technique for performing these functions for the individual real estate investor is desired.

### SUMMARY

The computer system and methods described herein address the aforementioned shortcomings in the prior art and provide an indispensable tool for the real estate investor to manage his or her real estate investments. In particular, the present invention relates to computer systems and methods by which an individual may simulate real estate or financial transactions over time, provide accounting and cash flow management for management of real estate investments, and track property values for rental properties taking into account tenant creditworthiness (tenant credit score) and the like.

The computer system preferably incorporates many features useful to the real estate investor. For example, a tenant reliability score (TRS) may be calculated and used when an individual real estate investor is contemplating whether to enter into a lease with a tenant. A lower TRS would alert the landlord that the tenant may not be a good risk. In addition, the TRS may be used to track expected future value of rental property because tenant credit worthiness is taken into account. A simulator preferably may incorporate the TRS into cash flow projections such that the investor could compare different potential tenants and determine potential differences in future net worth.

The present invention also includes a method of monitoring the financial performance of at least one managed real property unit. This method includes receiving at least one set of parameters describing information related to purchasing and disposing of one or more managed real property units. The method further includes receiving at least one set of parameters describing information related to the costs associated with owning at least one managed real property unit. Additionally, the method includes receiving at least one set of parameters describing the information related to incomes associated with one or more managed real property units. Based on these parameters, the present invention determines the cash and/or equity position of one or more managed real property unit. This information is then displayed in the form of income related statements, individual expense statements, and revenue statements for one or more managed real property units.

In accordance with another aspect of the invention, the financial performance of managed rental property units, including net cash flow and net equity, is addressed by calculating values such as: cash flow and equity of an individual managed real property unit, aggregate cash flow and equity of all the managed real property units, net effective gross income, operating income and taxable income based on gross rents possible, vacancy, operating expenses, interest expenses, property depreciation, and the like. The resulting accounting values and charts may be re-computed by modifying existing history, by altering a transaction, or by editing loan information.

In accordance with another aspect of the invention, a user may be able to print different reports including income related statements (income statement and balance sheet), expense statements, and revenue statements of the managed rental property units.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed.

In the drawings:

FIG. 1 is a block diagram representing a general purpose computer system in which aspects of the present invention and/or portions thereof may be incorporated.

FIG. 2 illustrates a simplified graphical user interface (GUI) of a real estate management system implemented on the computer system of FIG. 1.

FIG. 3 is a diagram illustrating a method of monitoring the financial performance of a managed rental property unit.

FIG. 4 is a diagram illustrating a method of adding or editing a financial transaction.

FIG. 5 is a diagram illustrating calculation of aggregate Cash and/or Equity of a managed rental property unit.

FIG. 6 illustrates a revenue summary statement of every managed real property unit.

FIG. 7 illustrates an expense summary statement of every managed real property unit.

FIG. 8 is a diagram illustrating a method of searching and editing a financial transaction.

FIG. 9 is a diagram illustrating a method of searching and editing a loan transaction.

FIG. 10 is a diagram illustrating an exemplary tenant reliability assessment module of the property management software module.

FIG. 11 is a diagram illustrating an exemplary method implemented by the simulator module for generating and displaying a simulated scenario.

FIG. 12 illustrates an exemplary user interface for a simulator used for managing real property.

FIG. 13 illustrates a second exemplary user interface for a simulator used for managing real property.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention. Similarly, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer both to methods and software for implementing such methods.

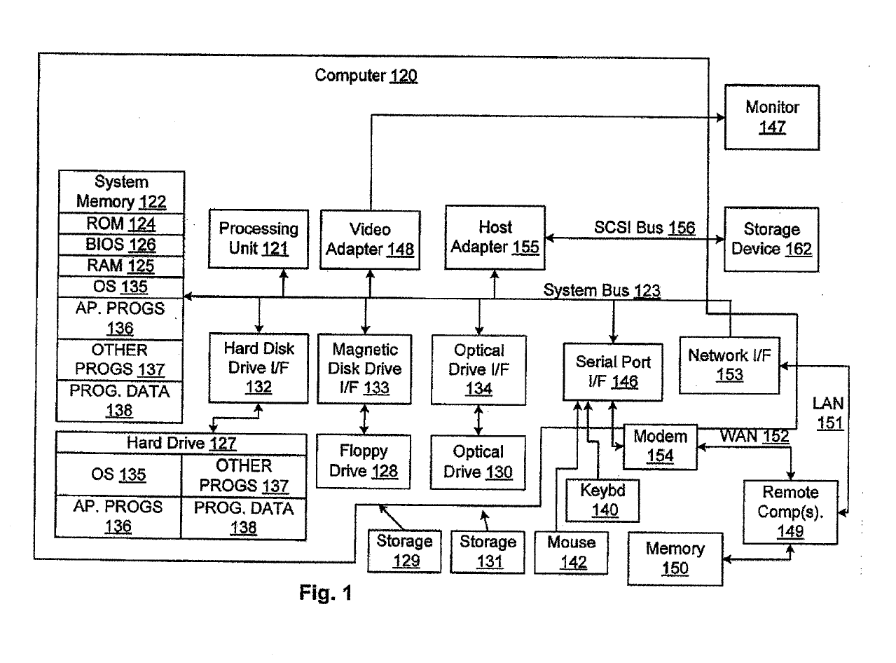

A detailed description of illustrative embodiments of the present invention will now be described with reference to FIGS. 1-13. Although this description provides a detailed example of possible implementations of the present invention, it should be noted that these details are intended to be exemplary and in no way delimit the scope of the invention.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any sub-combination. Further, references to values stated in ranges include each and every value within that range.

Generally, terms are to be given their plain and ordinary meaning such as understood by those skilled in the art, in the context in which they arise. To avoid any ambiguity, however, several terms are described herein.

As used herein, the term “disposing” refers to selling or otherwise transferring title to the property, either for value or without gaining value for the property, for profit, loss, or no gain. Disposing may include selling, gifting, trading for equivalent or non-equivalent property, or transferring by will.

In various embodiments, the information related to purchasing and optionally disposing of at least one managed real property unit comprises the property name, initial cost, closing costs, taxes, insurance, estimated selling price, estimated time of sale, or a combination thereof for each unit of managed real property. It should be appreciated that these features may be considered individually or in combination, and that other similar features equally fall within the teachings of this invention.

### Computer Environment

FIG. 1 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation, server or personal computer. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

FIG. 1 is a block diagram representing a general purpose computer system in which aspects of the present invention and/or portions thereof may be incorporated. As shown, the exemplary general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 120.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include a magnetic cassette, a flash memory card, a digital video or versatile disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a personal computer typically includes other peripheral output devices (not shown), such as speakers and printers. The exemplary system of FIG. 1 also includes a host adapter 155, a Small Computer System Interface (SCSI) bus 156, and an external storage device 162 connected to the SCSI bus 156.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets, and the Internet.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

Computer 120 typically includes a variety of computer readable storage media. Computer readable storage media can be any available media that can be accessed by computer 120 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 120. Combinations of any of the above should also be included within the scope of computer readable media that may be used to store source code for implementing the flow charts described in detail below.

### Software Modules

The computer system for managing real estate in accordance with the invention includes software modules that are loaded into the processing unit 121 of the exemplary computer system of FIG. 1 to implement the characteristic features described in detail below. The software modules will be described with respect to their functional flow as processed by processing unit 121 and with respect to the flow of information to and from a graphical user interface presented to the user on monitor 147 of the computer system of FIG. 1, for example.

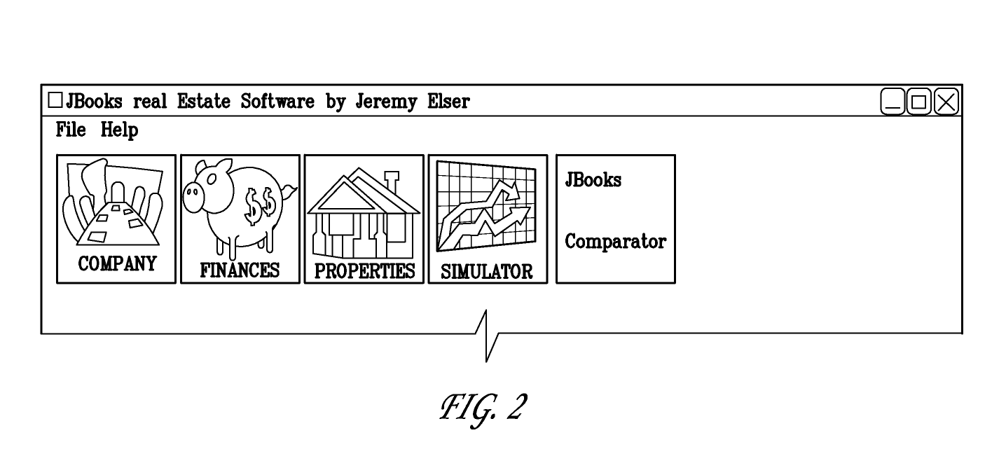

FIG. 2 illustrates a simplified graphical user interface (GUI) of a real estate management system implemented on the computer system of FIG. 1 in accordance with an exemplary embodiment of the invention. As illustrated, the user is presented with the options of selecting modules entitled “company,” “finances,” “properties,” and “simulator.” Each of these modules will be described herein in turn.

Company

If the user selects the “company” button in the GUI of FIG. 2, the user may view Notes, Company Details, and Summaries of the data input using the “finances,” “properties,” and “simulator” software modules described below.

The Notes viewer displays alerts that may be relevant to the user such as leases ending in 2 months or less, missed transactions, and transactions that are scheduled to occur in the near future. The Notes viewer also allows users to add and view customized notes.

The Company Details viewer stores the name of the user's company, the incorporation date, the Federal EIN, and the list of shareholders with their respective ownership percentages. This information is maintained so that custom reports and tax forms may be generated automatically. The user can add or modify this information at any time.

The Summaries viewer allows the user to view reports including income statements, balance sheets, checkbooks, tax help sheets, property summaries, revenue/expense summaries, recurring transactions, and total reports. These reports are automatically generated using the data entered in other modules of the software. The Summaries viewer also allows the user to convert these reports into printable PDFs.

In an exemplary embodiment, the company software module presents the user with the options of adding/removing shareholders, generating company financial reports, and the like. The company financial reports may include income statements, balance sheet, checkbook transaction listings, tax help sheets, property summaries, revenue/expenses based on existing checkbook registers, recurring transactions, and a cumulative “total” report including all of the above reports in a sensible order and format. These statements are completed automatically using the values stored for the property objects, tenant objects, and the like generated by the financial management and properties software modules described above. In this embodiment, these are editable (interactive) such that the user can probe how computed values were calculated (which transactions were involved and what mathematics were done on those transactions).

Finances

Those skilled in the art will appreciate that the information related to owning at least one managed real property unit includes outstanding loans, associated loan interest rates, taxes, insurance, maintenance costs, miscellaneous associated expenses, depreciation/amortization schedules, or a combination thereof for each unit of managed real property. Taxes may include state and local taxes, property taxes, and school taxes, but are not limited to these examples. Depreciation/amortization schedules may comprise straight line or double declining balancing formulae or other standard or non-standard formulae. Typically, the method uses formulae recognized by federal, state, and local tax authorities.

In one embodiment described herein, the loans are variable interest loans. In other embodiments, the loans are fixed interest loans. In still other embodiments, the loans are described by those skilled in the art as requiring “balloon” payments.

The invention provides methods that also include modifying information related to owning at least one managed real property unit and re-determining the cash and/or equity position of at least one managed real property unit. In certain embodiments, cash and/or equity positions are calculated based in the input parameters for at least one real property unit. Such positions may be calculated for multiple units. The input parameters on which these positions are calculated are based on financial transactions related to the property or properties. Such transactions include, but are not limited to receiving money (for example, rent or lease payments), expending money (for example, payments associated with purchase and closing costs, taxes, insurance, maintenance and repairs, and loans and loan interest), re-financing or re-valuing property, adjusting loan rates, (re-)defining depreciation periods or combinations thereof. In this regard, the term “property” refers to real and/or other depreciable property. The term “money” generally means cash or cash equivalents, including but not limited to credit or in-kind property.

The method of the invention may also include generating automated messages when a pre-determined cash position is triggered by one or more calculations or transactions. Non-limiting examples of such pre-determined cash positions may include a situation where the cash position goes negative (i.e., where one transaction reduces the cash reserves to the extent that there is insufficient cash to execute an otherwise allowable or anticipated expense), or at any point above or below a cash neutral position (e.g., at some pre-determined minimum cash reserve level). An attractive feature of the invention is that these methods also provide that these cash and/or equity positions may be presented to represent the individual or aggregated cash and/or equity position of at least one unit of managed real property in tangible form. That is, these positions may be displayed on video monitors, presented audibly, recorded in audio or video form, or provided in a written format, such that an interested party could access the information.

The invention provides that the format of the income related statements may comprise at least one income statement or balance sheet, reflecting the cash or equity position of at least one unit of managed real property unit. In cases where the income related statement reflects the cash position of at least one unit of managed real property, its contents may comprise annual effective gross income, annual net operating income and annual taxable income for at least one managed real property unit. The term “effective gross income” is a hybrid of realized and unrealized income and is defined to represent a realistic estimate of potential income from a specific unit of real property. It is calculated using gross rents possible, other income, potential income, vacancy, and combinations thereof for at least one managed real property unit. The term “gross rents possible” refers to a calculated value used to describe the unrealized but potentially available income from a given unit of real property. It may be calculated, for example, using a progression of best estimates based on available data of at least one managed real property unit. The net operating income is realized income calculated from the calculated effective gross income and operating expenses of at least one managed real property unit. The taxable income used herein is calculated from the calculated net operating income interest expense, and property depreciation of at least one managed real property unit.

In those cases where a balance sheet is used to define the equity position of at least one unit of real property, its contents may comprise total assets, total liabilities, total shareholder equity, and combination thereof. These terms are well understood by those skilled in the art.

As described herein, certain other embodiments describe the methods of managing the financial performance of at least one unit of managed real property as presenting individual income and/or expense statements of at least one managed real property unit. These statements may comprise monthly and/or total expenses of at least one unit of managed real property presented graphically, in tabular reports, or in some combination thereof, and may further comprise presenting a cash transaction history for each unit of property. This transaction history may comprise records of individual dated receipts, expenditures and optional descriptors associated with each receipt, expenditure, or both receipt and expenditure.

Further, the methods provide that individual transactions may be searched and edited. Other embodiments provide that the methods comprise listing and editing loan transactions and presenting amortization data of the edited loan transaction related to at least one unit of managed real property.

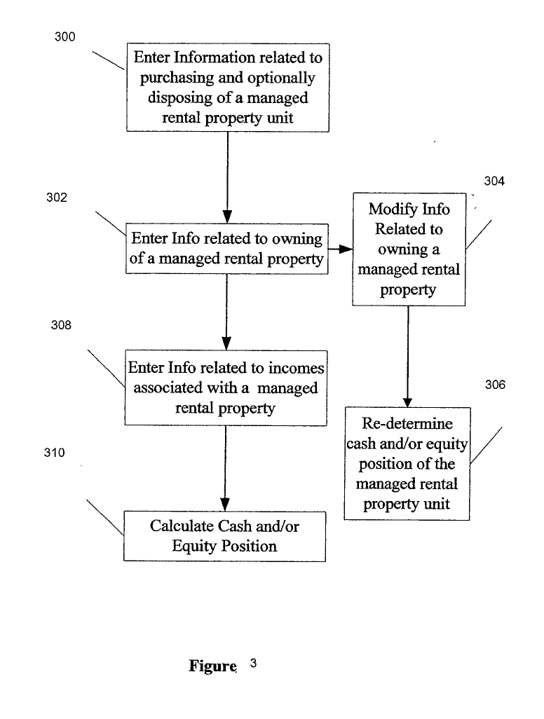

Several exemplary embodiments are provided in the accompanying figures. For example, FIG. 3 illustrates a method of monitoring the financial performance of a managed rental property unit. At 300, information related to purchasing or disposing a managed rental property unit may be entered. The parameters entered may include property name, initial cost, closing costs, taxes, insurance, estimated selling price, estimated time of sale, or a combination thereof for each unit of managed real property unit. The initial cost may comprise initial principal and down payment for buying a property. The closing cost may be the cost related to disposing of a property. The taxes and insurance may be the amount of taxes and insurance to be paid for each managed rental property unit. These values being of varying nature may later be overridden by just entering new values and applying the newly entered values. The selling price and the estimated time of sale or the combination thereof may be related to a sale of property and may be used to calculate fraction of the year value based on estimated date of sale. Such value may be used to calculate Applicable Depreciation Fraction (ADF) for each managed rental property unit. This estimated time of sale may be overridden at any time by entering new value of the date and applying the newly entered value to the entire system.

At 302, information related to owning of a managed real property unit may be entered. The owning information may comprise outstanding loan or loans, associated loan interest rates, taxes, insurance, maintenance costs, miscellaneous associated expenses, depreciation/amortization schedules, or a combination thereof for each unit of managed real property. The outstanding loan or loans may be the amount owed on the property to one or multiple lenders. The associated interest rate may be the interest rates that associated with each of the loan amounts owed. The maintenance cost may be the amount spent on maintaining a particular real property unit. The miscellaneous associated expenses may cover other expenses not covered under already defined categories of expenses. The depreciation or amortization schedule may be the schedule of loan payments associated with each property.

At 304, information related to owning a managed real property, e.g., interest rate, may be changed and at 306, the cash and/or equity position of the managed real property may be re-determined. Such a change could be made anytime and on the fly.

At 308, the information related to the incomes associated with a managed rental property unit may be entered. The incomes may mainly comprise rents received from each real property unit. The income, however, may be received from any other source.

At 310, the cash and/or equity position is calculated. Such calculation may be either made for each real property unit or as an aggregate for all the real property units. The cash and/or equity positions are determined based on financial transactions. In case of an individual property, the financial transactions may include the monies received from each real property unit, which could be either cash or cash equivalents, the monies spend on each real property unit, user estimated value of the property which could be based on any information available at the time of estimate.

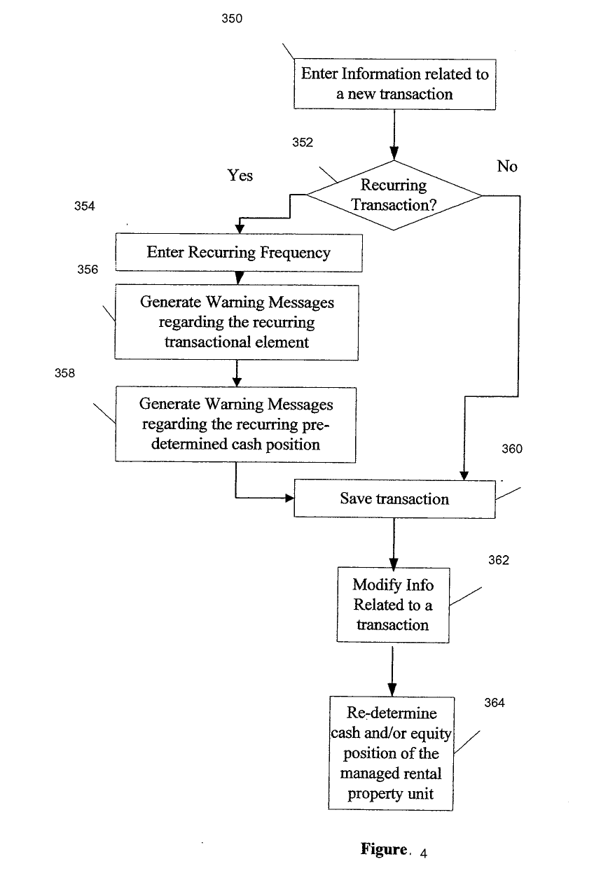

FIG. 4 illustrates method of adding and/or editing a transaction. At 350 information regarding a new transaction may be entered. The information may include date of the transaction, name of the transaction, the managed real property unit, which may be selected from an already available list of property units, the amount of transaction, amortization interval and whether the transaction is recurring or not. At 352, a determination is made whether the transaction is recurring. If the transaction entered is recurring, at 354 recurring frequency is added. The recurring frequency is the repetition detail which could either be any given number to times a year or any date of every month or every week. The end date of the recurrence may also be specified, after which the transaction may be non-recurring. At 356, warning messages regarding recurring transactional elements may be generated. For example, such messages may be generated if the amount due on a transaction was not paid on its due date. Such messages would be generated until the end date of a recurrence or forever if no end date of the recurrence was specified. At 358, warning messages regarding the recurring predetermined cash positions may be determined. A cash position may, for example, be a rent due from a tenant of a property unit. If the rent is not paid by its due date, the system may generate a warning message regarding non-receipt of the rent. The transaction is next saved at 360. As necessary, information related to the saved transaction is modified at 362 and the cash and/or equity position of the managed rental property unit is re-determined at 364. For example, if the transaction is a rental payment, the values impacted by the rental payment change are modified at 362 and the updated cash and/or equity position reflecting the rental payment is calculated at 364.

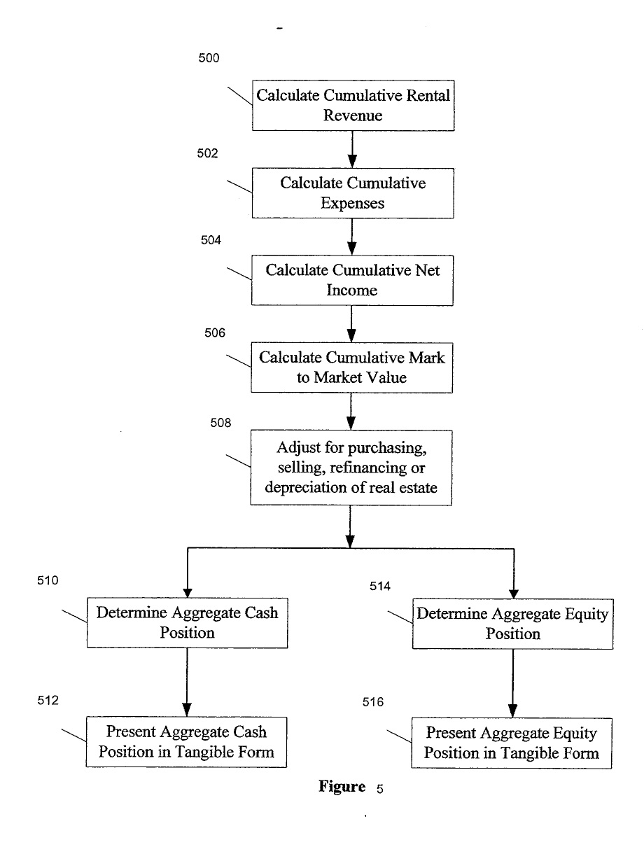

In case of an aggregate cash and/or equity position, calculations are based on cumulative money received, cumulative money expended, purchasing real and/or other depreciable property, selling real and/or other depreciable property, re-financing real and/or other depreciable property, re-valuing real and/or other depreciable property, adjusting loan rates, defining depreciation periods, or combinations thereof. FIG. 5 illustrates determination of cumulative cash and/or equity position of all real property units. At 500, cumulative rental revenue of all the managed real property units is calculated. The cumulative rental revenue represents the revenue from all managed real property units. The revenue may be received in the form of cash or cash equivalents. At 502, the cumulative expense related to all real property units is calculated. The expenses may include loan interest related to a managed rental property unit, utility payments made, supplies, insurance payments, advertising expenses, and miscellaneous expenses related to a managed real property unit. At 504, the cumulative net income from all the managed real property units is calculated. The cumulative net income is the difference between the cumulative revenue from all managed real property units and the cumulative expenses related to all managed real property units. At 506, the cumulative mark to market value of all of the managed real property units is calculated. Mark to market value is a user estimated value of the property based on current fair market price of the property unit. A person of skill in the art will appreciate that any standard accounting method will suffice in place of mark to market. At 508, the purchase of a new real property unit or the sale of an existing managed real property unit is taken into consideration. Also other events like refinancing a loan related to property unit or depreciation of real property unit is taken into consideration. At 510, the aggregate cash position is calculated as the net cash flow of all of the managed property units. The net cash flow is calculated from the cumulative rental revenue less the expenses plus adjustments made due to refinancing or depreciation, if any. At 512, the aggregated cash position may be presented in tangible form, for example, a printed report. At 514, the aggregate cash position is calculated as net equity of all the managed real property units which is the cumulative mark to market value of all the real property units less monies owed on all the managed real property units. At 516, the aggregated equity position may be presented in tangible form, for example, a printed report.

Income related statements may be generated reflecting the cash and/or equity position of a managed real property unit. The income related statements may be generated annually for each managed property unit or on the aggregate for all the managed real property units. The income related statements may comprise an income statement and a balance sheet of a managed real property unit. As shown in Table 1 below, the annual income statement may comprise annual effective gross income, annual net operating income and annual taxable income for at least one managed real property unit. The annual effective gross income as shown in row 6 of Table 1 may be calculated based on potential gross income as shown in row 4, and vacancy of a managed real property unit as shown in row 5 of Table 1. The potential gross income may comprise gross rents possible as shown in row 2 of Table 1, and other incomes as shown in row 3 of Table 1. The Gross Rents Possible (“GRP”) may be calculated by following a progression of best estimates depending on the data available. For example, if a real property unit has a lease for 3 months of a fiscal year, and another lease for the rest of the 9 months, the weighted average may be the best possible estimate of GRP. If the unit was not rented during a fiscal year whose GRP is being calculated, previous leases, with the recent lease having the priority is the best estimate. If the unit had never been rented prior to the fiscal year for which the GRP is being calculated, then the years following the fiscal year for which the GRP is being calculated are searched for the most applicable lease. If there are no leases pertaining to a particular managed real property unit, the unit may not be rentable, because the best estimate in that case may be 0.

A detailed history of leases is, therefore, essential for making an accurate estimate. The user of the system may, however, at any given time override the value of anticipated rent. After calculating the Potential Gross Income, the Effective Gross Income may be calculated from the Potential Gross income less vacancy for each real property unit. Vacancy may be calculated as the days for which a real property unit may have potential of earning an income but for some reason did not earn any income. For example in the year 2008, as shown in column 5, the Gross Rents Possible is $21700.00 and income from other sources is $150.00. The total Potential Gross Income, therefore, is $21850.00. Assuming that vacancy amount is $4300.00, the Estimated Gross Income, therefore, is $17550.00. The Net Operating Expenses are then calculated based on the Effective Gross Income less Operating Expenses. For example, the Operating Expenses for the year 2008 may be assumed to be $95000.00 as shown in row 7 and column 5 of Table 1. The Net Operating Income, therefore, is −$77450.00. The Taxable Income may then be calculated by further subtracting Interest Expenses related to the loans of a particular real property unit and depreciation of property. Assuming here that the total Interest Expense for the year 2008 is $4800.00 and the depreciation of property for the year 2008 is $2200, the Taxable Income, therefore would be −$84550.00, which means a loss in the amount of $84550.00.

TABLE 1
Annual Income Statement of Managed Real Property Units

| | Year | | | | |
|---|---|---|---|---|---|
| | 2005 | 2006 | 2007 | 2008 | 2009 |
| Gross Rents | 0.00 | 2900.45 | 10500.00 | 21700.00 | 35500.00 |
| Possible | | | | | |
| Other Income | 0.00 | 0.00 | 0.00 | 150.00 | 0.00 |
| Potential Gross | 0.00 | 2900.45 | 10500.00 | 21850.00 | 35500.00 |
| Income | | | | | |
| Vacancy | 0.00 | 2900.45 | 2200.00 | 4300.00 | 14000.00 |
| Effective Gross | 0.00 | 0.00 | 8300.00 | 17550.00 | 21500.00 |
| Income | | | | | |
| Operating | 0.00 | 31400.00 | 43000.00 | 95000.00 | 18000.00 |
| Expenses | | | | | |
| Net Operating | 0.00 | −31400 | −34700 | −77450.00 | 3500.00 |
| Income | | | | | |
| Interest Expenses | 0.00 | 0.00 | 0.00 | 4800.00 | 2100.00 |
| Property | 0.00 | 230 | 890.00 | 2200.00 | 4250.00 |
| Depreciation | | | | | |
| Taxable Income | 0.00 | −31630 | −35590.00 | −84450.00 | −2850.00 |

The Balance Sheet is calculated based on total assets, total liabilities and shareholder equity of all managed real property units. As shown in Table 2 below, The Total Assets are calculated by adding cash on hand with any pre-paid expenses and the price of real estate. For example, as shown below, if the cash on hand is $23288.00, with no pre-paid expenses, and the total value of real estate of all the managed real property units is $140527.00, the Total Assets would be $163815.00 as shown in row 5 of the Table 2.

TABLE 2
Balance Sheet

| | Value |
|---|---|
| Assets | |
| Cash | 23188.00 |
| Prepaid Expenses | 100.00 |
| Real Estate | 140527.00 |
| Total Assets | 163815.00 |
| Liabilities | |
| Unearned Revenue | 3055.00 |
| Long-Term Debt | 173175.00 |
| TOTAL LIABILITIES | 176230.00 |
| SHAREHOLDER EQUITY (SE) | |
| Capital Stock | 800.00 |
| Retained Earnings | −13215.00 |
| TOTAL SE | −12415.00 |
| LIABILITIES & SE | 163815.00 |

The liabilities are calculated based on the Unearned Revenue and Long-Term Debt, for example, the outstanding loan amounts on each real property unit. As shown in row 8 of Table 2, if the Unearned Revenue is $3055.00, and the Long Term Debit as shown in row 9 of Table 2 is $173175.00, then total liabilities is equal to $176230.00($3055.00+$173175.00). The Shareholder Equity is calculated based on the Capital Stock and Retained Earnings. The Capital Stock may be the stock issued by the company owning all the managed property units. If Capital Stock is $800.00, and Retained Earnings are $13215.00, then the total Shareholder Equity is −$12415.00. The total of Liabilities and Shareholders Equity is $163815.00 as shown in the last row of Table 2.

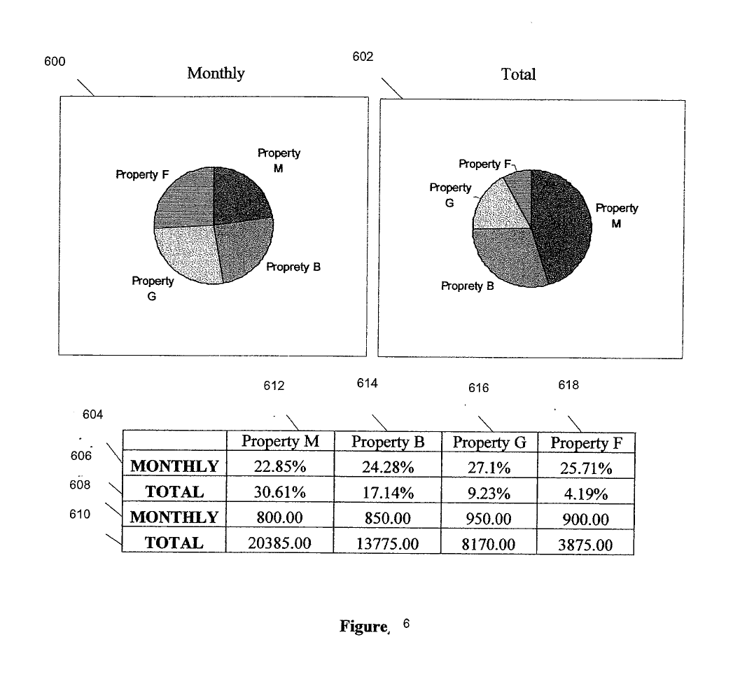

FIG. 6 illustrates a sample revenue summary statement of every managed real property unit. The statement may comprise graphical and tabular reports of monthly and total revenue from every managed real property unit. Chart 600 is a graphical representation of monthly revenue for a portfolio of properties M, B, G and F. The revenue from each real property unit is presented as a percentage of total revenue in that month. Chart 602 is a graphical representation of total revenue to date for each real property unit. Again the total revenue from each real property unit is presented as a percentage of aggregated total revenue to date. Such data may be helpful for a small investor to identify real property units that are more profitable as compared to the ones that are less profitable. The table 604 in FIG. 6 is an example of a tabular report for properties B, F, G, and M. The row 606 represents percentage contribution of each property to the overall revenue. The row 608 represents percentage contribution of each property into overall total revenue of all real property units. Row 608 represents actual monthly contribution of each property unit, whereas row 610 represents actual total contribution of each real property unit to date. The columns 612 to 618 represent contributions and percentages for Property M, B, G and F, respectively.

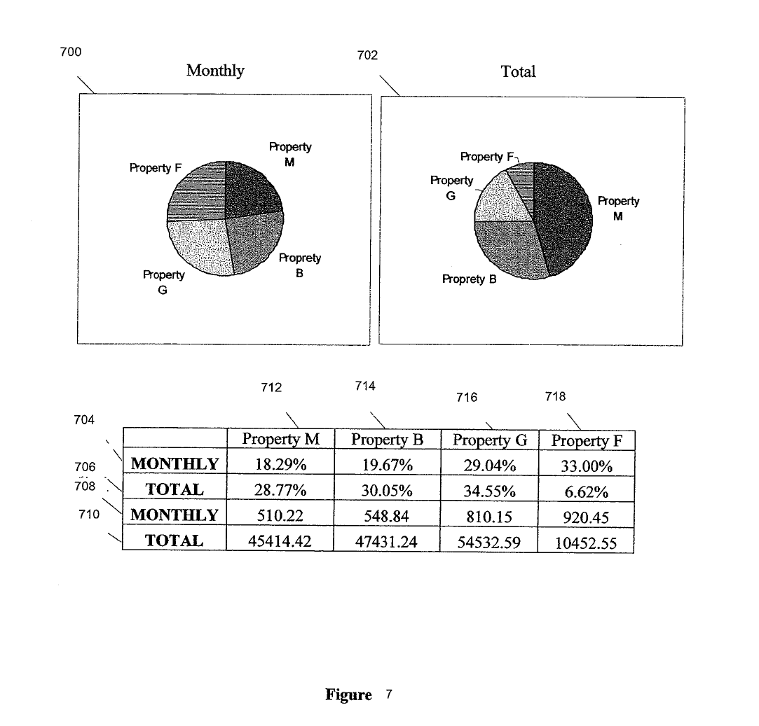

FIG. 7 illustrates expense summary statement of every managed real property unit. The statement may comprise graphical and tabular reports of monthly and total expenses of every managed real property unit. Graph 700 is a graphical representation of monthly expenses for properties M, B, G and F. The expense of each real property unit is presented as a percentage of total expense in that month. Graph 702 is a graphical representation of total expense to date for each real property unit. Again, the total expense of each real property unit is presented as a percentage of aggregated total expense to date. The table in FIG. 7 is an example of tabular report of expenses related to each managed real property unit. The row 704 represents percentage expense contribution of each property to the total monthly expense of all managed real property units. The row 706 represents percentage contribution of each property into overall total expense of all real property units. Row 708 represents actual monthly expense of each property unit, whereas row 710 represents actual total expense of each real property unit to date. The columns 712 to 718 represent contributions and percentages for real property units M, B, G and F, respectively.

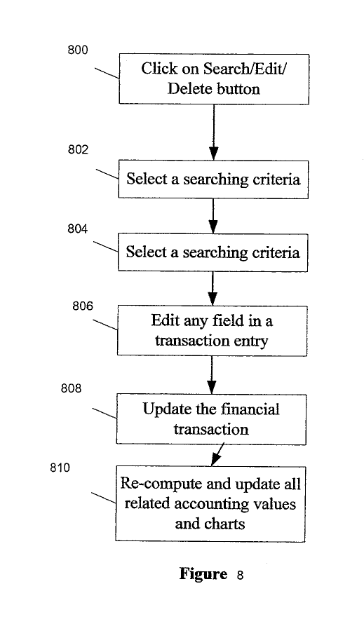

FIG. 8 illustrates method of searching and editing a financial transaction entered into the financial management system of the invention. At 800, a user may click on the “Search/Edit/Delete Transactions” button presented to the user via a user interface (not shown). At 802, the user may then be presented with a screen to enter a searching criterion. The searching criteria may be based on a bank account, data range, transaction name or a fragment of a transaction name, the managed real property unit, transactional type or an amount range. The transactional type may be a standard one, e.g., supplies, maintenance, utility, tax or a user defined criteria that starts with the word “Other,” for example “Other(non-Tax).” The user may enter one of the criteria and click on the continue button. At 804, the user may be presented with a list of transactions matching the search criteria.

At 806, the user may click on any of the transactions presented and edit any field in a transaction entry. At 808, the user may update an element of the selected transaction. For example, user may click on amount related to a transaction and edit the corresponding value. The user then clicks on the “Enter These Updates” button. At 810, all accounting values and charts related to the updated transaction amount will be recomputed and updated.

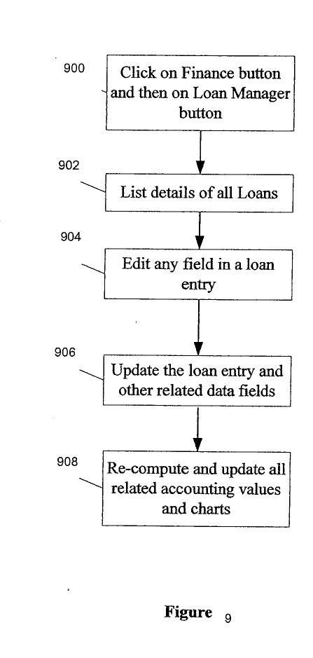

FIG. 9 illustrates method of searching and editing a loan transaction. At 900 a user may click on a Loan Manager button presented to the user via a user interface (not shown). At 902, the user may then be presented with a Loan Summary listing the outstanding loans as shown in Table 3 below.

TABLE 3
Loan Summary

| | | | Start | End | APR | Monthly | Original | |
|---|---|---|---|---|---|---|---|---|
| Loan Name | Project | Collat. | Date | Date | (%) | Payment | Principal | Balance |
| Property M | M1 | M1 | Apr. 1, 2008 | Apr. 1, 2023 | 6.5 | 90.05 | 4800.00 | 0.00 |
| Primary Loan | | | | | | | | |
| Property M | M2 | M1 | May 2, 2008 | May 2, 2038 | 7.0 | 231.00 | 38000.00 | 25245.08 |
| Secondary | | | | | | | | |
| Loan | | | | | | | | |
| Property B | B1 | B1 | Jun. 1, 2008 | Jun. 1, 2023 | 6.5 | 298.47 | 35000.00 | 30069.31 |
| Primary Loan | | | | | | | | |
| Property G | G1 | B1 | Sep. 30, 2008 | Sep. 30, 2023 | 5.0 | 0.00 | 1400.00 | −1.22 |
| Primary Loan | | | | | | | | |
| Property F | F1 | F1 | Jul. 15, 2009 | Jul. 15, 2024 | 9.0 | 580.23 | 55000.00 | 52485.35 |
| Primary Loan | | | | | | | | |

The first column of Table 3 lists the managed real property unit the loan is associated with. The second column of Table 3 lists the name or address of the real property the loan amount is associated with. The third column of Table 3 lists the name of the collateral to the loan, if the loan is secured. The fourth and fifth columns list the start and end dates of the loan and seventh column lists the annual percentage rate for each loan amount. For variable-rate loans, an editable schedule of dates on which the loan APR is changed and the resulting new APR will be created by the user. All computations referencing loan payment transactions will reference the APR schedule to determine the APR at the time of the transaction. The seventh column lists the monthly payment due for each loan amount based on the current APR (as described in the APR schedule). The eighth column lists the Original Principal paid for each loan amount and tenth column lists the balance that is due for each loan amount, which may increase based on transactions that are withdraws from the loan account as in lines of credit. The ninth column traces the history of financial transactions for all credits and debits that would affect the current balance—increasing balance for withdraws on the account and decreasing the balance with each transaction that is a loan payment, referencing the APR schedule to determine the proper amount of principal, as would be understood by someone skilled in the art.

Each row of Table 3, therefore, represents details about each real property unit. For example, in row 1 is listed “Property M Primary Loan” that is associated with M1 property. The collateral for this property is again M1 with the start date as Apr. 1, 2008 and end date as Apr. 4, 2023, which means it is a 15 year loan with APR of 6.5%. The monthly payment for this loan is 90.05 with an original principal of $4600.00. The balance on this loan is $0.00, which indicates that the loan is paid off.

At 904, the user may click on any of the entries of the loan summary table and edit the corresponding value. At 906, the user may update the loan detail value. In an exemplary embodiment, the user may edit APR information related to a loan amount and then may click on “Enter These Updates” button at 908, and all accounting values and charts related to the updated loan amount may be recomputed and updated. The user may then request amortization of the newly updated loan information. This provides the user with a flexible way of updating any transactional element at any given time. This allows users to change a given APR one or more times in the case of variable APR loans. A variable APR loan is a loan that has a fluctuating interest rate. The interest rate increases and decreases based on an index rate.

The financial software module also includes a comparing unit for comparing the financial performance of the user's managed real property units. The comparison report preferably includes Net Flip Income and the Net Monthly Income for every unit as shown in Table 4 below.

TABLE 4
Project Comparison

| | Property M | Property B | Property G | Property F |
|---|---|---|---|---|
| Resale Price | 88000 | 8800 | 88000 | 88000 |
| Purchase Price | 20261.38 | 31900 | 29700 | 45336.69 |
| Rehab/Hold | 18779.32 | 7767.969 | 6870.336 | 3475.692 |
| Net Flip Income | 48959.3 | 48332.03 | 51429.66 | 39187.62 |
| Monthly | 797.5 | 797.5 | 797.5 | 852.5 |
| Revenue | | | | |
| Monthly Loans | 287.463 | 316.217 | 579.953 | 611.721 |
| Monthly Taxes | 195.261 | 231.132 | 270.875 | 241.274 |
| Monthly | 55.363 | 42.075 | 33.737 | 37.4 |
| Insurance | | | | |
| Monthly Misc. | 0 | 0 | 0 | 0 |
| Net Monthly | 259.413 | 208.076 | −87.065 | −37.895 |
| Cash Flow | | | | |

The Net Flip Income is calculated based on Resale Price less Purchase Price, and Rehab/Hold. For example, for property M with Resale Price of $88000, Purchase Price of $20261.38, and Rehab/Hold of 18779.32, the Net Flip Income for Property M is $48959.3 ($88000−20261.38−18779.32).

The Net Monthly Cash Flow is calculated based on Monthly Revenue, Monthly Loans, Monthly Taxes, Monthly Insurance, and Monthly Miscellaneous Costs. For example, for property M with Monthly Revenue of $797.50, Monthly Loans of $287.46, Monthly Taxes of $195.26, Monthly Insurance of $55.36, and no Monthly Miscellaneous Costs, Net Monthly Cash Flow may be $259.41 as shown in last column of the Table 4. The user may similarly calculate Net Monthly Cash Flow for every other real property unit and compare the Net Monthly Cash Flow with every other real property unit. One of skill in the art will appreciate that an alternative embodiment may include the calculation of variable APR loans. The user will be able to manually modify cash flow information based on changing percentage rates for certain loans.

The financial software module also permits the user to set up and manage a bank account, including managing transactions (including recurring transactions) in the form of a computerized checkbook. As noted above, the financial software module also permits the user to manage more complicated transactions such as loan and property purchases with fixed or variable APRs. The software also permits the user to enter tenant information for rental properties and to effectively manage the financial aspects of the property. As will be explained in more detail below, a module may also be provided that permits the user to evaluate the reliability of existing tenants and to determine the expected reliability of possible tenants.

The financial software module thus provides a method of managing the financial information associated with at least one real property unit. In an exemplary embodiment, the financial software module comprises a real property management software program embedded in a computer-readable medium and run by a processor such as processing unit 121 of FIG. 1. In the exemplary embodiment, the financial software module is implemented using object-oriented programming techniques and includes the following features:
(a) at least one property object is provided corresponding to a unit of real property, wherein each property data object comprises at least one property object element, each property object element corresponding to a financial attribute of the corresponding unit of real property;
(b) a user may change at least one property object element of at least one property object either once or as a function of time;
(c) at least one tenant object is provided corresponding to a tenant, wherein each tenant object comprises at least one tenant object element, each tenant object element corresponding to a tenant attractiveness attribute of the corresponding tenant;
(d) a user may change at least one tenant object element of at least one tenant object;
(e) at least one transactional day object is provided corresponding to a 24 hour period, wherein each transactional day object comprises at least one transactional element, each transactional element corresponding to a financial transaction which occurred during the corresponding day;
(f) a user may enter or edit at least one transactional element at least once a day;
(g) a user may calculate the equity position of at least one unit of real property; and
(h) a user may prepare income statements or balance sheets or both, reflecting the cash and equity position of at least one unit of real property.

One or more of these property objects may be provided by the user of the program or by a third party software designer. The financial management software may also allow or enable the user to add additional or edit existing property object/elements to customize for his or her personal use.

In much the same way, certain embodiments provide tenant objects and transactional day objects that are software constructs representing at least one tenant and transactional day, respectively. Each tenant object represents a different tenant (or set of co-tenants). As with the property objects, the software may allow or enable the user to add additional or edit existing tenant or transactional day object/elements to customize for his or her personal use.

Each tenant object may comprise at least one tenant object element, each tenant object element corresponding to an attribute associated with the corresponding tenant. Generally, these attributes comprise quantifiable factors related to the tenant, the market, or a combination thereof, such that each tenant object element is a mathematical composite of at least one quantifiable factor related to the tenant, the market, or a combination thereof. These quantifiable factors which relate to the tenant may comprise standardized credit scores, estimated free cash flow, ability to pay, payment history, or a combination thereof. The factors which relate to the market comprise local, regional, or national occupancy/vacancy rates, unemployment rates, or a combination thereof.

In certain other embodiments, each transactional day object corresponds to a 24 hour period. Each transactional day object comprises at least one transactional element. Each transactional element corresponds to a financial transaction which occurred during the corresponding day. As described earlier, the financial transaction comprises receiving money, expending money, purchasing real and/or other depreciable property, selling real and/or other depreciable property, re-financing real and/or other depreciable property, re-valuing real and/or other depreciable property, adjusting loan rates, defining depreciation periods, or combinations thereof.

Certain embodiments provide methods further comprising enabling a user to establish recurring entries of at least one transactional element. In other embodiments, the software is further capable of prompting and optionally prompts the user with messages regarding at least one recurring transactional element, particularly regarding a pre-determined cash position, which is triggered by an entry or edit of at least one transactional element.

The invention also provides a method further comprising enabling a user the financial management software to calculate and optionally present in tangible form (where the term “tangible form” here has the same connotations and meaning as described above) the individual equity position of each of at least one unit of real property, where when at least two units of real property are considered, the combined equity position of the at least two units of real property, or both the individual and collective equity positions of the at least two units of real property are calculated as well. Another attractive feature of the financial management software module is that the user may make such calculations and/or present the results of such calculations.

Several additional features of the financial management software further enable the user to prepare income statements, balance sheets, or both, reflecting the cash or equity position or both of at least one unit of real property. Other embodiments describe the user actually preparing these income statements, balance sheets, or both. These income statements, balance sheets, or both present financial parameters including revenue, expenses, net income, cash flow, or property value, where the user is enabled to define and defines the timeframes for presenting these financial parameters. Certain non-limiting examples of such timeframes can be monthly, annually, the total holding time, or a combination thereof. The term “total holding time” refers to the time from original acquisition to either the time of calculation or disposal.

Certain attractive embodiments enable the user to present, and for the user to actually present, the income statements, balance sheets, or both, in tangible form, for each individual unit of real property, for the combined portfolio of the at least two units of real property, or for both the individual unit or collective portfolio of at least two units of real property in tangible form. These income statements, balance sheets, or both can represent changes in cash or equity for single or multiple timeframes.

In other embodiments, the tangible form is of a format to be accepted by the banking industry, at least one investment community and/or at least one government tax agency for its intended purpose. Non-limiting examples of such purposes include obtaining loans or supporting tax reporting.

In other embodiments, the methods further comprise enabling the user to present, and for the user to present, a cash transaction history for each unit of real property, where the transaction history comprises records of individual dated receipts, expenditures and optional descriptors associated with each receipt, expenditure, or both receipt and expenditure. Further, the methods describe enabling the user to search and edit individual transactions related to each unit of real property, and for the user to do the same.

Properties

If the user selects the “properties” button in the GUI of FIG. 2, a property management software module is invoked that presents the user with menu options for entering data that identifies the real property under management. For example, the user may alter property information such as loans against the property, interest rate, rental status, and the like. The user may also manage tenants by creating a new tenant object or editing an existing one. Also, as will now be explained, a mechanism may also be provided whereby a user of the software module may evaluate the reliability of actual or prospective tenants.

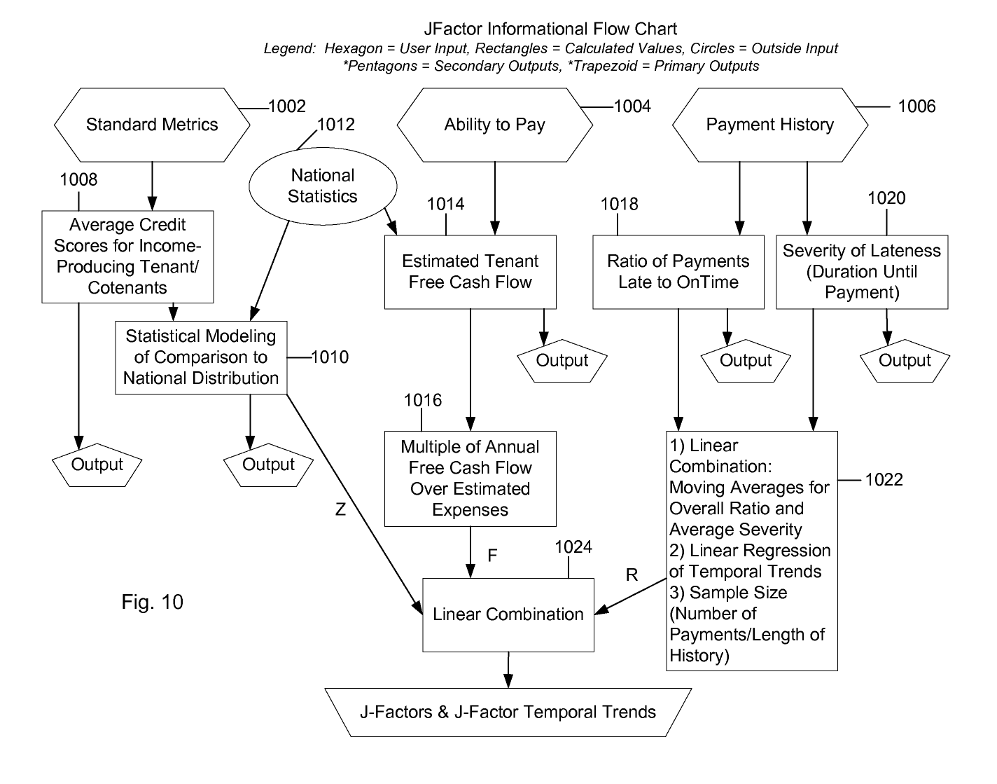

FIG. 10 illustrates an exemplary tenant reliability assessment module of the property management software module. The reliability assessment module of FIG. 10 evaluates the reliability of rental property tenants based on a number of parameters received from publicly available sources and/or from information provided by the tenant or prospective tenant. For example, the tenant reliability assessment (TRA) module may receive standard metric parameters of the tenant and/or co-tenants (hereinafter tenant) at 1002. Such information may include, for example, tenant/cotenant credit scores, credit histories, and the like. At 1004, the TRA module further receives ability to pay parameters describing the tenant's ability to pay. Such parameters may include, for example, tenant/content income, number of dependents, known expenses, and the like. At 1006, the TRA module receives payment history parameters that describe the payment history of the tenant, including the timeliness of the tenant's payments.

At 1008, the TRA module receives the standard metrics from 1002 and generates average credit scores for tenants/cotenants based on the received standard metrics. At 1010, national, regional, and/or local statistics (hereinafter statistics, unless otherwise noted) 1012 are compared to a statistical model for tenants based on a national, regional and/or local distribution of paying tenants. The values determined at 1008 and 1010 may be selectively output to the user. Similarly, at 1014, the TRA module receives the ability to pay parameters for the tenant and compares these values to statistics to a statistical model of national, regional and/or local statistics of cash flow for tenants and estimates the tenant's free cash flow. This tenant's estimated free cash flow may be output to the user and/or a value may be calculated at 1016 that is a multiple of the tenant's free cash flow over the tenant's estimated expenses. A relatively high multiple indicates that the tenant's finances are relatively more reliable than a tenant with a low multiple. Finally, at 1018 and 1020, the TRA module calculates from the tenant's payment history data a ratio of payments late to on-time and the severity of lateness (duration until payment). These values may be output to the user and/or linearly combined at 1022 to determine moving averages for the payment ratio and the average severity of lateness.

At 1024, the TRA module linearly combines the computation data of blocks 1010, 1016, and 1022 to generate a tenant reliability score for the tenant based on a predetermined formula. The tenant's reliability score is normalized and presented to the user for use in evaluating his or her tenants and/or prospective tenants.

As noted above, the standard metric parameters 1002 may include tenant credit scores. Credit scores can include the FICO score, which is developed and distributed by Fair Isaac Company, and is well known in the prior art. Credit scores are also created by the three national credit reporting agencies (also called credit bureaus) Equifax, Experian, and TransUnion. The credit scores from Equifax, Experian, TransUnion, and Fair Isaac all can be calculated differently, but the general rule is that a higher score is better than a lower score. Credit scores takes into account the credit history of a tenant. Credit history can include account payment information on specific types of accounts (credit cards, retail accounts, installment loans, finance company accounts, mortgage, etc.), presence of adverse public records, collection items, and past due items, length and amount of delinquency, number of accounts paid on-time, amount owed on and number of specific accounts, length of credit history, and number of accounts and recent credit inquiries.

As also noted above, the ability to pay parameters 1004 may include tenant income, number of dependents, and known expenses. In addition, ability to pay parameters 1004 can also take into account the reliability of an employer that provides the tenant's income. For example, a certain numerical value may be given to a tenant's employer depending on whether the tenant is employed by the United States or a foreign government, a United States or foreign private company, or a United States or foreign public company. Furthermore, a value can be placed on number of people the tenant's employer employs, the profitability of the employer, and other common financial accounting and company and/or government valuation measures.

The aforementioned payment history parameters 1006 may include on-time payment data as well as length of time until payment is recorded, if a payment is late for the tenant in the current rental property. In addition, payment history parameters 1006 may include on-time payment data and length of time until payment was recorded for past rental properties, if those parameters are available. For example, tenants are assigned to lease objects (which have an associated property, property unit, start date, end date, and total dollar amount over the life of the lease). Tenants can be assigned to one property at one time, and a different property later. The payment history includes all transactions with that tenant.

In one embodiment of the TRA module, after a tenant's standard metrics are received at 1002, income-producing tenants can be defined as tenants who have an income, for example, via their own business, employment, or non-earned income sources such as interest and dividends. A landlord will usually only check the main income producer (the main income producer is the tenant with the highest income). If there is a stay at home parent, or a child, that person's credit is generally not worth the price to ascertain. However, a landlord may choose to check more than one tenant's score and then use an average of the checked credit scores. National, Regional, and/or Local Statistics 1012 would be repositories of average credit scores (FICO scores), income, housing expenses, and income-to-debt ratios (i.e. anticipated monthly expenses versus monthly income). These are available on a variety of government and commercial websites. These parameters can be automatically downloaded and updated periodically from a server or website that offers these parameters. Credit score statistics can be the average credit score of a nation, region, and/or locality reported by any agency purporting to have obtained a national, regional, and/or local average credit score. Using the national, regional, and/or local statistics along with the average credit scores for income-producing tenants, statistical modeling that compares the tenant's data to a national distribution is calculated and labeled the “Z score.” The Z score is the tenant's standard deviation from national average FICO score. Calculating the Z score is a standard procedure for dealing with random variables that are approximately normal (also known as Gaussian Distributions). The Z score is calculated by taking the tenant's FICO score, subtracting the national average FICO score, and then dividing by the standard deviation of the FICO score random variable. In another embodiment, the Z score may be assigned a grade (A+ through F) so that users unfamiliar with statistics will understand the meaning of the score more easily. The grades are simply evenly distributed over the range of Z scores (−3 to 3).

In one embodiment of the TRA module, estimated tenant free cash flow statistics, for example, can be the average tenant free cash flow of a nation, region, or locality reported by any agency purporting to have obtained tenant free cash flow statistics. Using the national, regional, and/or local statistics 1012 along with the tenant's own estimated tenant free cash flow from his or her rental application, the tenant's data may be compared to a national distribution and labeled the Free Annual Cash Multiple, variable F, at 1016. More basically, variable F may be calculated by taking the annual income of the tenant family and dividing that by the annual rent, using the information from the assigned lease (i.e., F=Tenant Annual Income/Annual Rent). In another embodiment, the variable F may be displayed as its inverse (Annual Rent/Tenant Annual Income) so that users unfamiliar with statistics will understand the meaning of the variable more easily.

In an embodiment of the TRA module, moving averages for the overall ratio of late payments to on-time payments can be calculated at 1018 and moving averages for average severity of lateness can be calculated at 1020. When available, payment history of a tenant's past rentals may be included, for example, in order to enable this parameter to be more accurate. For example, Reliability, variable R, may be calculated as the percentage of on-time payments (i.e., R=#on-time/(#on-time+#late)).

Using these averages Z, R, and F, a linear regression over time may be calculated at 1024 to determine the tenant reliability score. In another embodiment, the tenant reliability score may be calculated as follows, which allows the tenant reliability score to remain a positive number with a value normalized between 0 and 100: Tenant Reliability Score=[(F/2)*(3+Z)*R]*3. The Tenant Reliability Score is then displayed to the user (landlord). In another embodiment, the Tenant Reliability Score, the Z score shown as a letter grade, the inverse of the variable F, and variable R are displayed along with tenant information for use by the landlord in making rental decisions.

Simulator

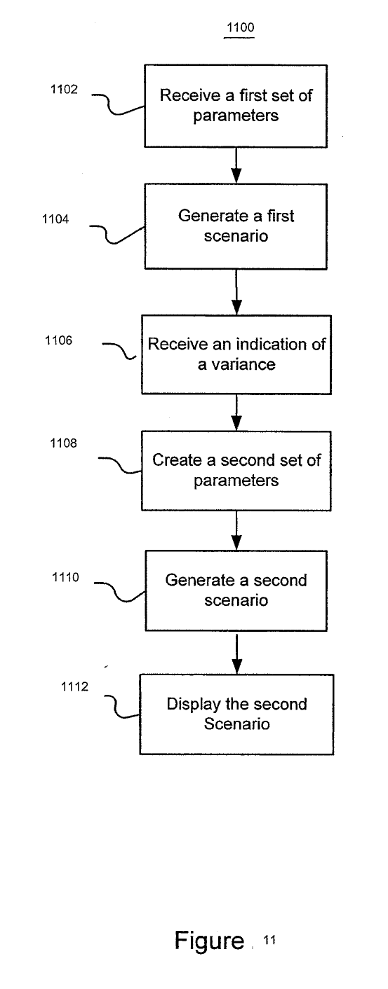

If the user selects the “simulator” button in the GUI of FIG. 2, a simulator software module is invoked that permits the user to take all of the available information stored in the system about the user's properties, tenants, transactions, loans, company finances, etc., and to present a calendar marked with each transaction as it is expected to occur as well as the resultant cash balance after the indicated transaction. This information is then used to generate “what if” scenarios so that the user may simulate what would happen if, for example, a tenant stops paying in March or a new property is purchased in May of next year for a given amount with specified loan parameters. The simulator also permits the user to see what would happen to his or her finances if taxes were paid early to obtain a discount, if repairs are deferred, etc. The simulator module will now be described with respect to FIGS. 11-13.

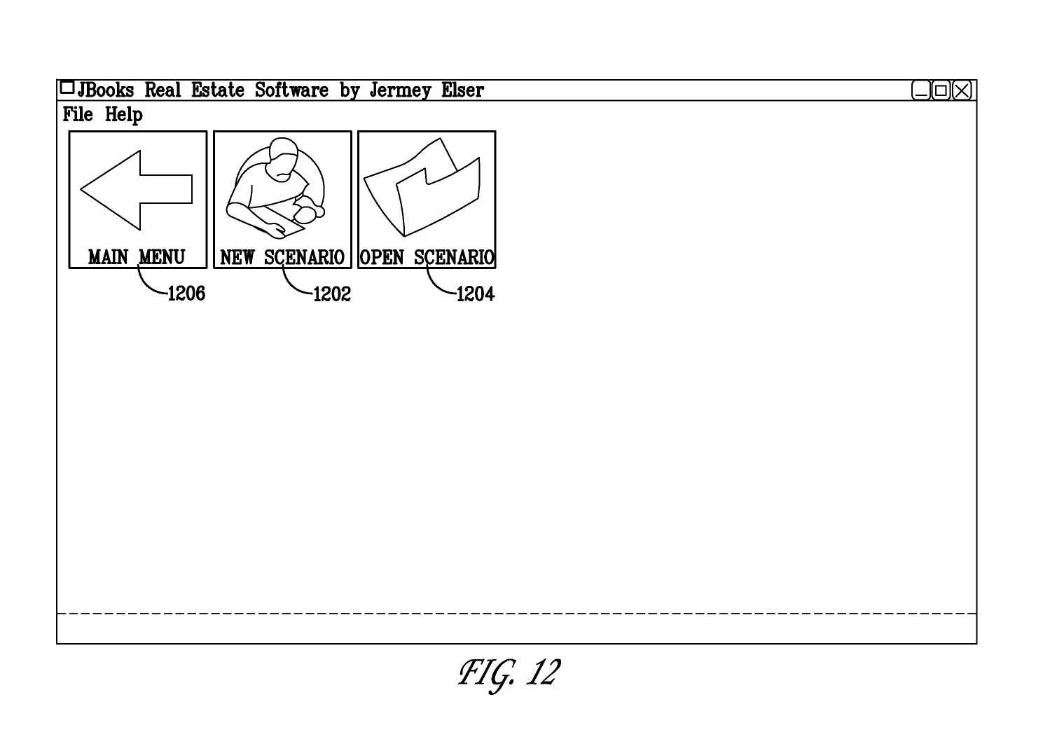

FIG. 11 illustrates an exemplary method 1100 implemented by the simulator module for generating and displaying a simulated scenario. A scenario may indicate financial status and/or determine possible current, previous, or future financial status of a user with regard to the managed real property. For example, a real scenario may be based on real data that exists with regard to the managed real property that may be tracked and/or calculated as described above in connection with the financial management software module. A simulated scenario may be based on hypothetical information, fictional information, projected information, and/or real information that may differ from the real scenario as it exists at a given time. A simulated scenario may predict future financial status and/or determine possible current or previous financial status of a user with regard to the managed real property. According to one embodiment, method 1100 may be implemented, for example, via a user interface such as that illustrated in FIG. 12. As illustrated, a user may elect to generate a new scenario or to open and view a previously generated scenario.

Referring back to FIG. 11, one generates a scenario for the simulator by inputting a first set of parameters at 1102. For example, the first set of parameters may include financial parameters, real property parameters, rental parameters, and/or other parameters that may be relevant to real property management. According to one embodiment, the first set of parameters may be based on real data that exists with regard to the managed real property. According to another embodiment, the first set of parameters may be based on hypothetical information, fictional information, projected information, and/or real information that may differ from the real scenario as it exists at a given time. In one embodiment, financial parameters may include financial information that describes the financial status of one or more managed real properties, and/or the financial status of a real property management company. Financial parameters may include bank account information such as checking account balance or savings account balance, loan information such as mortgage payments and/or other financial information that may tracked in the system as described above. Real property parameters may define the managed real property. Real property parameters may include, but are not limited to, transactions related to a managed real property such as buying, selling and altering a managed real property. Rental parameters may describe the rental status and relevant transactions related to one or more managed real properties. Rental parameters may include but not limited to, renting a managed property, vacating a managed property, rental payment information, and/or rent due date.

The financial, real property, and rental parameters may be received, for example, from a database or data store, via user input, by loading data from a previously saved scenario, and/or any other means such that the parameters may be provided to generate a stimulated scenario.

If the user selects an existing scenario, the user may modify an existing simulated scenario that may be based on real financial information that may be related to the user's managed real property and/or a combination of real financial information that may be related to the user's managed real property and previous simulated information. A previously created and/or stored scenario may be imported so that parameters associated with the saved scenario, such as financial information, recurring transactions, loan information, managed property information, rental information, bank balances, or the like from a previously saved file may be applied to real scenario information.

The parameters received at 1102 may be stored in a data store such that changing parameters in a stimulated scenario would not disturb the information related to the real scenario stored in the system. For example, the received parameters may be saved in a temporary file, a separate database, or any other data store that may be distinguished from the database that stores information related to the real scenario.

As shown in FIG. 11, at 1104, a first scenario is generated based upon the received first set of parameters. For example, the simulated scenario may be generated based on the financial parameters, the real property parameters, and/or the rental parameters that are received at 1102. According to one aspect of the embodiment, the user may specify a begin date and an end date of the simulated scenario at 1104. Cash balance for each calendar day in the specified simulation period may be calculated based on the parameters received at 1102. For example, for each calendar day, the system may search for transactions that apply to that particular day, and associate the relevant transactions with the particular day. Cash balance for the particular day may be calculated based on one or more transactions and/or other parameter information that may impact cash balance associated with that particular day. According to one aspect of an embodiment, the cash balance of a given day may be calculated as the Aggregate Cash Position described above using the parameters that are received at 1102.

A simulated scenario may be saved. For example, the current state of the simulation, including but not limited to, recurring transactions, deleted occurrences of transactions, one-time transactions, loan information, property information, and/or the calculated cash balances may be saved in a data store. As described above, a saved scenario may be opened subsequently by a user.

As shown in FIG. 11, at 1106, an indication of a variance in at least one of the received parameters may be received from the user. For example, a user may indicate that a managed real property is to be sold on a particular day. At 1108, a second set of parameters may be created based on the indication received at 1106. For example, in response to the user's indication that a managed real property is to be sold on a particular day, the system may create a second set of parameters indicative of the sale of a particular property in the user's real estate portfolio.

As shown in FIG. 11, at 1110, a second scenario may be generated as a simulated scenario. By way of example, a user may indicate that a managed real property is to be sold on a particular day. The system may increase the cash amount, and end recurring transactions associated with the managed real property. In another example, the user may indicate that a real property is to be purchased on a particular day. The cash amount may be reduced, transactions associated with the added real property may be added, and rental information related to the real property may be specified. In yet another example, the user may indicate that a managed real property is to be rented. The system may set up recurring rental transactions that may be associated with the managed real property. In other examples, changes to a parameter may include vacating a property, adding a transaction, removing a transaction, creating a new loan, and/or altering an existing loan. Accordingly, the simulated scenario may be updated, and cash balances for each calendar day may be re-calculated based on the updated scenario. The updated simulated scenario may be displayed to the user as desired at 1112. The second scenario also may be printed into an electronic file in specified format, such as a PDF format, Microsoft Word format, graphical format, database format, list format, or any other format which may output and/or display the information specified by the user. Transactions associated with each day, transaction amount, and new cash balance of each day may be output in the specified format.

As noted above, FIG. 12 depicts an exemplary user interface for a simulator used for managing real property in accordance with the invention. As shown in FIG. 12, the simulator interface may include an object for creating a new simulated scenario such as the “New Scenario” button 1202, an object for opening and/or displaying a previously created simulated scenario such as the “Open Scenario” button 1204, and/or an object for returning the user to the application's main menu such as the “Main Menu” button 1206.

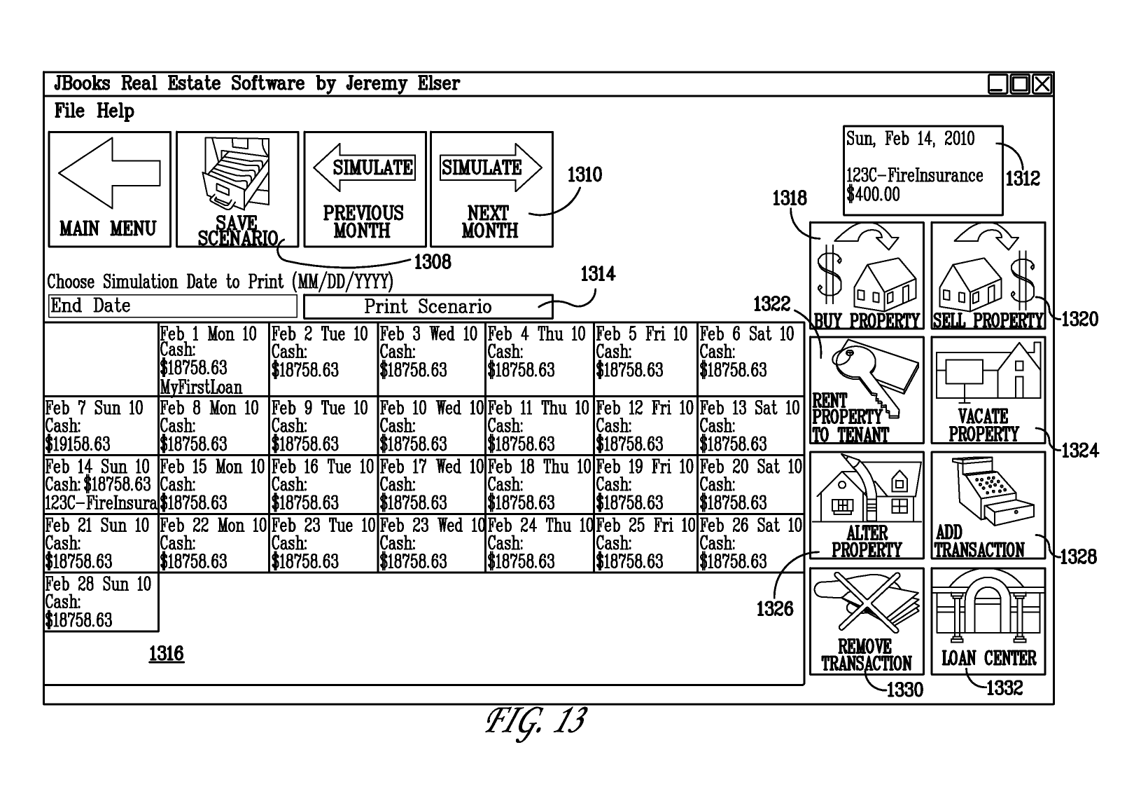

The “New Scenario” button 1202 or the like may allow the user to interact with and/or prompt the user for information with regard to various options for creating a new simulated scenario. According to one embodiment, the “New Scenario” button 1202 may allow a user to create a new simulated scenario that may be based on real and/or simulated scenario information related to the users managed real property, such as the simulated scenario illustrated in FIG. 13. The real and/or simulated scenario information may include financial information, recurring transactions, loan information, property information, rental status information or any other information that may help a user in managing real property.

The “Open Scenario” button 1204 or the like may allow the user to load a previously created and/or stored simulated scenario. According to one embodiment, the “Open Scenario” button 1204 may allow a user to load real and/or saved simulated scenario information from a previously saved file and apply the saved real and/or simulated scenario information to the current real scenario information. For example, the user may load a saved simulated recurring transaction and apply the recurring transaction to the starting cash balance calculated for the day of the simulation, and add and/or subtract each amount moving forward or backward in time as the user clicks through the calendar months.

FIG. 13 illustrates another exemplary user interface for a user to interact with the simulator for managing real property. As shown in FIG. 13, the simulator interface may include additional objects for managing and/or interacting with a real scenario to create a simulated scenario. According to one embodiment, the simulator interface may include objects for managing a simulated scenario such as an object for saving the current simulated scenario such as the “Save Scenario” button 1308, an object for viewing additional real scenario and/or simulated scenario information such as the “Simulate Next Month” button 1310, an object for outputting the current and/or previous simulated scenario such as the “Print Scenario” button 1314, or any other object which may allow a user to manage a new or previously created simulated scenario.

The “Save Scenario” button 1308 or the like may allow a user to save the current state of the simulated scenario and/or any portion of the current state of the simulated scenario on the computing device memory so that the saved scenario may be recalled at a later date. According to one embodiment, the current state of the simulator may include recurring transactions, deleted occurrences of transactions, one-time transactions, loan information, property information, rental status information and/or any other information which may be tracked and/or recorded by the simulator.

The “Simulate Next Month” button 1310 or the like may allow a user to view additional real scenario and/or previous simulated scenario information not currently displayed. According to one embodiment, selection of the “Simulate Next Month” button 1310 or the like may display a new iteration of real scenario and/or previous simulated scenario information. For example, the currently displayed real scenario and/or previous simulated scenario information may be displayed in monthly increments, as shown in FIG. 13, and the user may select the “Simulate Next Month” button 1310 to view the real scenario and/or previous simulated scenario for the month following the month currently being viewed.

The “Print Scenario” button 1314 or the like may allow a user to output and/or display a simulated scenario to the user. According to one embodiment, the “Print Scenario” button 1314 may allow the user to output and/or display the current state of the simulator or the state of the simulator at a given date or set of dates specified by the user. The simulator may output and/or display the simulated scenario in a format such as a PDF format, Microsoft Word format, graphical format, database format, list format, or any other format which may output and/or display the information specified by the user. The output and/or display may be in the form of a screen display, a tangible output such as a printed paper, or any other form of output. According to one example embodiment, the user may input the date or dates into the simulator that the user may want to print and the simulator may provide a PDF document which may be printed by the computing device.

The simulator interface may also include objects for interacting with a real scenario to create a simulated scenario. According to one embodiment, the objects for interacting with the real scenario to create a simulated scenario may include an object for adding and/or editing real and/or simulated scenario information such as text box 1312, an object for displaying real and/or simulated scenario information such as the display table 1316, an object or objects for simulating changes with regard to a user's real property, an object or objects for simulating changes in financial information, and/or any other object for interacting with a real scenario to create a simulated scenario.

The display table 1316 or the like may display real and/or simulated scenario information related to the management of real property such as financial information, property information, rental status information, and/or any other information that may be used in managing the user's real property. According to one embodiment, the display table 316 may display real and/or simulated scenario information in a table format, database format, list format or the like. The display table 316 also may display information according to the dates on which the real and/or simulated scenario information was recorded such as a yearly format, monthly format, weekly format, daily format, or the like.

The text box 1312 or the like may allow a user to interact with the real and/or simulated scenario information so that the user may create a simulated scenario, while still preserving the real scenario information. According to one embodiment, the text box 1312 or the like may allow a user to input real and/or simulated scenario information, edit existing real and/or simulated scenario information, and/or delete existing real and/or simulated scenario information. According to an exemplary embodiment, the user may select a date on the display table 1316 and the real and/or simulated scenario information may be displayed in the text box 1312 so that the user may input additional information, edit displayed information, and/or delete displayed information to create a simulated scenario.

The object or objects for simulating changes with regard to a user's real property may include objects such as the “Buy Property” button 1318, the “Sell Property” button 1320, the “Rent Property to Tenant” button 1322, the “Vacate Property” button 1324, the “Alter Property” button 1326, and/or any other objects that may simulate changes with regard to a user's real property in creating a simulated scenario.

The “Buy Property” button 1318 or the like may simulate the purchase of a property by a user. According to one embodiment, selection of the “Buy Property” button 1318 may prompt the user for a unit name, a purchase price, an asking price, a rental amount, a rent payment frequency, a rent payment schedule, property insurances, property taxes, and/or any other information related to the property which may influence the management of a user's real property.

The “Alter Property” button 1326 or the like may simulate a change in a selected property such as financial status, rental status, ownership status or the like. According to one embodiment, the “Alter Property” button 1326 may display all real and/or simulated scenario information for the selected property on the date and/or dates selected by the user so that the user may add to, edit, and/or delete information related to the selected property.

The “Sell Property” button 1320 or the like may allow a user to simulate the sale of a property in managing the user's real properties. According to one embodiment, the “Sell Property” button 1320 may end all recurring transactions for that property.

The “Rent Property to Tenant” button 1322 or the like may allow a user to simulate the effect of renting a property in managing the user's real properties. According to one embodiment, the “Rent Property to Tenant” button 1322 may set the status of the rental unit to “Rented” on the chosen day. The simulator may then apply rental income to the days following the day on which the rental unit is set to “Rented.”

The “Vacate Property” button 1324 or the like may allow a user to simulate the termination of a lease in managing the user's real properties. According to one embodiment, the “Vacate Property” button 1324 may set the status of the rental unit to vacant on the chosen day. The simulator may then not to apply the rental income to the days following the day on which the rental unit is vacated.

The object or objects for simulating financial information may include objects such as the “Add Transaction” button 1328 for the addition of a new transaction to the real scenario, the “Remove Transaction” button 1330 for simulating the removal of a transaction form the real scenario, the “Loan Center” button 1332 for simulating the addition and/or removal of loan information from the real scenario, and/or any other object for simulating financial information to create a simulated scenario.

The “Add Transaction” button 1328 or the like may allow a user to simulate the addition of a financial transaction or changing an existing transaction in managing the user's real properties. Upon selection of the “Add Transaction” button 1328, the user may be prompted for information related to the financial transaction such as a transaction date, a transaction name, a related property, credit and/or debit information, an amount, amortization dates, and/or any other information related to a financial transaction. The simulator may only display a list of transaction types that correlate to the type of transaction selected by the user. For example, if the transaction selected is a credit transaction, the list of transaction types applying to credit transactions may appear. In another example, if the transaction selected is related to a loan, the user may be prompted to choose an existing loan to which to apply the transaction. According to another embodiment, if the transaction selected is a new recurring transaction, then the user may be prompted for recurrence frequency information such as number of times the transaction occurs per year, per month, per week, per quarter, per half year, per day, or the like.

It is to be appreciated that while these methods provide certain embodiments, the invention is intended to describe not only these general methods, but any software (and hardware) which may used to implement these methods as well as the use of software to do so. While the invention is versatile enough to provide for other methods, and without limiting the scope of the invention, it is also convenient to describe the invention in terms of an object oriented computer method.

These embodied software programs require use of computers, including main-frame and/or personal computers, thereby rendering the computers purpose-built tools for this purpose, transforming input into output parameters. In these embodiments, the property object is a computer construct within a software program which represents a unit of real managed property. The software program may be comprised of multiple property objects, representing multiple units of real managed property. Similarly, the property object construct comprises property object elements, each corresponding to at least one financial attribute of the corresponding unit of real property. As with the methods described above, such financial attributes may comprise initial cost, closing costs, outstanding loan or loans, associated loan interest rates, rental incomes, taxes, insurance, maintenance costs, miscellaneous associated expenses, occupancies or vacancies, estimated selling price, estimated time of sale, depreciation/amortization schedules, or a combination thereof for each unit of real property. As above, the loan interest rates may be variable, fixed, or be characterized as requiring so-called “balloon” payments. In general, the property object and elements may be considered to be a mathematical composite of one or more financial attribute of the corresponding unit of real property. The term “mathematical composite” describes that the various elements may be combined arithmetically, geometrically, logarithmically, or some combination thereof, using weight factors which describe the relative importance of each parameter.

What is claimed:

1. A computer-implemented method of monitoring the financial performance of at least one managed real property unit over time, comprising:
the computer receiving at least one set of parameters related to purchasing and optionally disposing of said at least one managed real property unit;
the computer receiving at least one set of parameters related to ongoing maintenance costs of said at least one managed real property unit;
the computer receiving at least one set of parameters related to rental income associated with said at least one managed real property unit;
the computer calculating the cash and/or equity position of said at least one managed real property unit at different points in time;
the computer receiving modified data based on transactions affecting the cash and/or equity position of said at least one managed real property unit and recalculating the cash and/or equity position of said at least one managed real property unit based on said modified data; and
displaying the recalculated cash and/or equity position of said at least one managed real property unit.

2. The method of claim 1, further comprising the computer determining aggregate cash and/or equity positions over at least two managed real property units in a real estate investment portfolio and displaying the aggregate cash and/or equity positions in such a way that the relative value of one real property unit to another may be ascertained from the display.

3. The method of claim 2, further comprising the computer generating income statements reflecting the cash and/or equity position of said at least one managed real property unit and/or income statements reflecting the aggregate cash and/or equity position of said at least two managed real property units.

4. The method of claim 1, wherein the parameters related to purchasing and optionally disposing of said at least one managed real property unit comprise property name, initial cost, closing cost, tax, insurance, estimated selling price, estimated time of sale, or a combination thereof for each said at least one managed real property unit.

5. The method of claim 1, wherein the parameters related to ongoing maintenance costs of said at least one managed real property unit comprises an outstanding loan, associated loan interest rate, tax, insurance, maintenance cost, miscellaneous associated expenses, depreciation/amortization schedule, or a combination thereof for each said at least one managed real property unit.

6. The method of claim 5, wherein said associated loan interest rate is variable.

7. The method of claim 1, wherein the transactions comprise receiving money, expending money, or combinations thereof.

8. The method of claim 2, wherein the aggregate cash and/or equity positions are determined based on financial transactions including cumulative money received for all real property units, cumulative money expended for all real property units, purchase, sale, and/or refinancing of real property units, adjustment of loan rates, variation of depreciation periods for the real property units, or combinations thereof.

9. The method of claim 1, wherein the computer generates warning messages regarding the cash or equity position in response to an actual or proposed transaction affecting the cash and/or equity position of said at least one manage real property unit.

10. The method of claim 3, wherein the income statement comprises annual effective gross income, annual net operating income and annual taxable income for said at least one managed real property unit.

11. The method of claim 10, wherein the effective gross income is calculated based on gross rents possible, other income, potential income, and vacancy of said at least one managed real property unit.

12. The method of claim 11, wherein the gross rents possible is calculated by following a progression of best estimates based on available rent data for said at least one managed real property unit.

13. The method of claim 2 wherein the computer generates a comparison report that compares Net Flip Income and Net Monthly Income of every one managed real property unit with another managed real property unit.

14. The method of claim 13, wherein the Net Flip Income of a managed real property unit is calculated based on Resale Price, Purchase Price, and Rehab/Hold Price.

15. The method of claim 13, wherein the Net Monthly Cash Flow for a managed real property unit is calculated based on Monthly Revenue, Monthly Loans, Monthly Taxes, Monthly Insurance, and Monthly Miscellaneous Costs for the managed real property unit.

16. A computer-implemented method for managing real property, the method comprising:
receiving a first set of parameters on a processor, wherein the first set of parameters comprises a financial parameter describing the financial status of the real property, a property parameter defining the real property, and a rental status parameter describing the rental status of the real property;
generating, on the processor, a first scenario based upon the received first set of parameters;
receiving an indication of a variance in at least one of the financial parameter, the property parameter, or the rental status parameter;
creating a second set of parameters based on the indication received;
generating a second scenario based on the varied second set of parameters that preserves the first scenario and identifies parameter values at another point in time; and
displaying the second scenario.

17. The computer-implemented method of claim 16, further comprising saving at least one of the first or the second scenarios to a memory.

18. The computer-implemented method of claim 17, wherein receiving a first set of parameters comprises retrieving a saved scenario from the memory.

19. The computer-implemented method of claim 16, wherein the first set of parameters is based on real data that exists with regard to the managed real property.

20. The computer-implemented method of claim 16, wherein at least one of the parameters of the second set of parameters is based on at least one of hypothetical data, fictional data, or projected data.

21. The computer-implemented method of claim 16, wherein the financial parameter further comprises at least one of a checking account balance, a savings account balance, a loan balance, or a mortgage balance.

22. The computer-implemented method of claim 16, wherein the property parameter comprises at least one of the following: a unit name, a purchase price, an asking price, a rental amount, a rent payment frequency, a rent payment schedule, property insurance information, or property taxes.

23. A method for determining reliability of a tenant of a managed rental property comprising:
receiving standard metrics of the tenant;
receiving payment history statistics of the tenant;
receiving the tenant's ability to pay;
receiving national statistics relating to the tenant;
calculating a reliability score of the tenant based on the standard metrics, the payment history, the ability to pay and the national statistics; and
displaying the reliability score of the tenant.

24. The method of claim 23, wherein standard metrics of the tenant further comprise a credit score for the tenant.

25. The method of claim 24 further comprising calculating a Z score by taking the tenant's credit score, subtracting the national average credit score, and dividing by a standard deviation of a credit score random variable.

26. The method of claim 23 wherein standard metrics of the tenant further comprise an average credit score for more than one tenant.

27. The method of claim 25 further comprising calculating a Z score by taking the tenant's average credit score, subtracting the national average credit score, and dividing by the standard deviation of the credit score random variable.

28. The method of claim 23 wherein ability to pay of the tenant comprise reliability data of an employer that provides the tenant's income data.

29. The method of claim 28 wherein reliability data of an employer that provides the tenant's income is determined based on data comprising who employs the tenant, number of employees employed by the employer, the profitability of the employer, financial data of the employer, other valuation measures of the employer, or combinations thereof.

30. The method of claim 23 wherein ability to pay of the tenant further comprise national, regional, and/or local statistics.

31. The method of claim 23 wherein ability to pay of the tenant is calculated by taking the annual income of the tenant's family and dividing that by the annual rent, using the information from the assigned lease.

32. The method of claim 23 wherein payment history parameters of the tenant further comprise on-time payment data as well as length of time until payment is recorded.

33. The method of claim 23 wherein payment history parameters of the tenant further comprise on-time payment data and length of time until payment is recorded for past rental properties.

34. A system for monitoring the financial performance of at least one managed real property unit over time, the system comprising:
a memory that stores at least one set of parameters related to purchasing and optionally disposing of said at least one managed retail property unit, at least one set of parameters related to ongoing maintenance costs of said at least one managed real property unit, and at least one set of parameters related to rental income associated with said at least one managed real property unit; and
a processor configured to calculate the cash and/or equity position of said at least one managed real property unit at different points in time, and said processor configured to receive modified data based on transactions affecting the cash and/or equity position of said at least one managed real property unit and recalculating the cash and/or equity position of said at least one managed real property unit based on said modified data; and
a display for displaying the recalculated cash and/or equity position of said at least one managed real property unit.

35. The system of claim 34, wherein the processor further determines aggregate cash and/or equity positions over at least two managed real property units in a real estate investment portfolio and the display displays the aggregate cash and/or equity positions in such a way that the relative value of one real property unit to another may be ascertained from the display.

36. The system of claim 35, wherein the processor further generates income statements reflecting the cash and/or equity position of said at least one managed real property unit and/or income statements reflecting the aggregate cash and/or equity position of said at least two managed real property units.

37. The system of claim 34, wherein said associated loan interest rate is variable.

38. The system of claim 35, wherein the aggregate cash and/or equity positions are determined based on financial transactions including cumulative money received for all real property units, cumulative money expended for all real property units, purchase, sale, and/or refinancing of real property units, adjustment of loan rates, variation of depreciation periods for the real property units, or combinations thereof.

39. The system of claim 34, wherein the processor generates warning messages regarding the cash or equity position in response to an actual or proposed transaction affecting the cash and/or equity position of said at least one manage real property unit.

40. The system of claim 35 wherein the processor generates a comparison report that compares Net Flip Income and Net Monthly Income of every one managed real property unit with another managed real property unit.

41. The system of claim 34, wherein the memory further stores a first set of parameters including a financial parameter describing the financial status of the real property, a property parameter defining the real property, and a rental status parameter describing the rental status of the real property, and wherein the processor generates a first scenario based upon the received first set of parameters, the processor further receiving an indication of a variance in at least one of the financial parameter, the property parameter, or the rental status parameter, creating a second set of parameters based on the indication received, and generating a second scenario based on the varied second set of parameters that preserves the first scenario and identifies parameter values at another point in time, and wherein said display displays the second scenario.

42. The system of claim 41, wherein the memory stores at least one of the first or the second scenarios.

43. The system of claim 42, wherein the processor retrieves a scenario containing the first set of parameters from the memory.

44. The system of claim 41, wherein at least one of the parameters of the second set of parameters is based on at least one of hypothetical data, fictional data, or projected data.

45. The system of claim 34, wherein the memory further stores standard metrics of the tenant, receiving payment history statistics of the tenant, the tenant's ability to pay, and national statistics relating to the tenant, the processor further determines reliability of the tenant by calculating a reliability score of the tenant based on the standard metrics, the payment history, the ability to pay and the national statistics, and the display displays the reliability score of the tenant.

46. The system of claim 45, wherein the processor further calculates a Z score by taking the tenant's credit score, subtracting the national average credit score, and dividing by a standard deviation of a credit score random variable.

47. The system of claim 45 wherein the processor further calculates a Z score by taking the tenant's average credit score, subtracting the national average credit score, and dividing by the standard deviation of the credit score random variable.

48. The system of claim 45 wherein payment history parameters of the tenant further comprise on-time payment data as well as length of time until payment is recorded.

49. The system of claim 45 wherein payment history parameters of the tenant further comprise on-time payment data and length of time until payment is recorded for past rental properties.

50. A computer-readable storage medium storing computer executable instructions thereon that when processed by a computer cause the computer to implement a method of monitoring the financial performance of at least one managed real property unit over time, said storage medium comprising:
cash calculation code that calculates the cash and/or equity position of said at least one managed real property unit at different points in time;
cash recalculation code that recalculates the cash and/or equity position of said at least one managed real property unit based on said computer receiving modified data based on transactions affecting the cash and/or equity position of said at least one managed real property unit; and
display code that displays the recalculated cash and/or equity position of said at least one managed real property unit on a display,
wherein said cash recalculation code and/or cash calculation code calculations are based on at least one of a set of parameters related to purchasing and optionally disposing of said at least one managed real property unit, at least one set of parameters related to ongoing maintenance costs of said at least one managed real property unit, and at least one set of parameters related to rental income associated with said at least one managed real property unit.

51. The medium of claim 50, further comprising aggregate cash/equity code that determines aggregate cash and/or equity positions over at least two managed real property units in a real estate investment portfolio and displays the aggregate cash and/or equity positions in such a way that the relative value of one real property unit to another may be ascertained from the display.

52. The medium of claim 51, further comprising income statement generation code that generates income statements reflecting the cash and/or equity position of said at least one managed real property unit and/or income statements reflecting the aggregate cash and/or equity position of said at least two managed real property units.

53. The medium of claim 50, wherein said associated loan interest rate is variable.

54. The medium of claim 51, wherein the aggregate cash and/or equity positions are determined based on financial transactions including cumulative money received for all real property units, cumulative money expended for all real property units, purchase, sale, and/or refinancing of real property units, adjustment of loan rates, variation of depreciation periods for the real property units, or combinations thereof.

55. The medium of claim 50, further comprising warning generating code that generates warning messages regarding the cash or equity position in response to an actual or proposed transaction affecting the cash and/or equity position of said at least one manage real property unit.

56. The medium of claim 51 further comprising report generating code that generates a comparison report that compares Net Flip Income and Net Monthly Income of every one managed real property unit with another managed real property unit.

57. The medium of claim 50, further comprising code for receiving and storing a first set of parameters including a financial parameter describing the financial status of the real property, a property parameter defining the real property, and a rental status parameter describing the rental status of the real property, and simulator code that generates a first scenario based upon the received first set of parameters and, upon receiving an indication of a variance in at least one of the financial parameter, the property parameter, or the rental status parameter, creates a second set of parameters based on the indication received and generates a second scenario based on the varied second set of parameters that preserves the first scenario and identifies parameter values at another point in time, wherein said display code displays the second scenario.

58. The medium of claim 57, wherein the simulator code retrieves a scenario containing the first set of parameters from a memory.

59. The medium of claim 57, wherein at least one of the parameters of the second set of parameters is based on at least one of hypothetical data, fictional data, or projected data.

60. The medium of claim 50, further comprising code for receiving and storing standard metrics of the tenant, receiving payment history statistics of the tenant, the tenant's ability to pay, and national statistics relating to the tenant, and tenant reliability code that determines reliability of the tenant by calculating a reliability score of the tenant based on the standard metrics, the payment history, the ability to pay and the national statistics, wherein the display code displays the reliability score of the tenant.

61. The medium of claim 60, wherein the tenant reliability code further calculates a Z score by taking the tenant's credit score, subtracting the national average credit score, and dividing by a standard deviation of a credit score random variable.

62. The medium of claim 60 wherein the tenant reliability code further calculates a Z score by taking the tenant's average credit score, subtracting the national average credit score, and dividing by the standard deviation of the credit score random variable.

63. The medium of claim 60 wherein payment history parameters of the tenant further comprise on-time payment data as well as length of time until payment is recorded.

64. The medium of claim 60 wherein payment history parameters of the tenant further comprise on-time payment data and length of time until payment is recorded for past rental properties.
